(19) United States
(12) Patent Application Publication
(10) Pub. No.: US 2006/0227550 A1
(43) Pub. Date: Oct. 12, 2006

(54) Flexible conducting wire structure having light emitters

(75) Inventor: Wen-Shin Huang, Taoyuan Hsien (TW)

Correspondence Address: BRUCH E. TROXELL;Suite 1404, 5205 Leesburg Pike, Falls Church, VA, 22041, US

(73) Assignee: Wen-Chung HUANG

(21) Appl. No.: 11/099,644

(22) Filed: Apr. 6, 2005

(51) Int. Cl. F21S 4/00

(52) U.S. Cl. 362/252; 362/249; 362/800; 362/240

(57) ABSTRACT

A flexible conducting wire structure having light emitters is disclosed. Two flexible conducting wires with different polarities and a plurality of light emitting diodes having a plurality of chips having first electrodes and second electrodes are provided. The first electrodes of the light emitting diodes are electrically connected with one of the flexible conducting wires. The second electrodes of the light emitting diodes are electrically connected with the other of the flexible conducting wires via an extremely fine conducting wire. The chips of the light emitting diodes, the flexible conducting wires, and locations therebetween are covered with a layer of transparent adhesive for providing an transparent protective cap for the chips and the extremely fine conducting wire. The flexible conducting wires are covered with a layer of transparent insulating adhesive respectively for forming an insulating wire cover to avoid the occurrence of short circuit.

### FIELD OF THE INVENTION

The present invention relates to a flexible conducting wire structure, and more particularly to a flexible conducting wire structure having light emitters.

### BACKGROUND OF THE INVENTION

In the commonly seen decorative light that winds around the decorations, the light holders are mounted on two insulated conducting wires for obtaining electrical connection, and lamps or light emitting diodes are assembled on the light holders. When the external power is supplied to the insulated conducting wires, the light is emitted from the lamps or the light emitting diodes.

On the basis of the above-mentioned description, the light emitters, for example, the lamps or the light emitting diodes, must be first assembled on the light holders so that the external voltage can excite the electrons to emit the light. This kind of assembly wastes time and manpower, and does not provide the economic scale that the electronic-society looks forward to. Therefore, it does not provide the economic benefits. Besides, the poor assembly between the light emitters and the light holders also affects the quality of the product and causes the poor electrical contact or short circuit. Consequently, the complicated quality control must be subsequently performed. This result indicates that the practicability of the prior art needs to be improved.

### SUMMARY OF THE INVENTION

In order to conform to the usage requirements for the decorative light and reduce the production cost, the present inventor discloses a flexible conducting wire structure having light emitters.

According to the initial concept of the present invention, in order to improve the conventional formation method that additionally assembles the light emitting diodes, the light emitting diodes of the present invention are coupled with the conducting wires without the use of the light holders, and the external voltage is applied to excite the electrons of the light emitting diodes for emitting the light. Therefore, the costs of the light holders are saved. Besides, the surface mounting technology (SMT) can be also applied to rapidly complete the electrical connection between the light emitting diodes and the conducting wires. Therefore, the manufacturing efficiency is significantly improved and the products can be massively manufactured, thereby providing a production method that provides the economic benefits: and that satisfies the requirements for reducing production cost and accelerating the manufacturing speed.

According to the adopted technology of the present invention, the chips of the light emitting diodes are directly bonded on one of two flexible conducting wires having different polarities by use of the surface mounting technology. The electrodes of the chips are connected with the other flexible conducting wire via a conducting wire. Next, the flexible conducting wires and the chips are coated with a layer of transparent adhesive for forming an insulating protective cap. Thereafter, the flexible conducting wires are coated with a layer of transparent insulating adhesive respectively for forming an insulating wire cover. Consequently, the flexible conducting wire structure having light emitters is accomplished.

It is a main object of the present invention to provide a flexible conducting wire structure having light emitters for acting the decorative light that generally winds around the decorations.

It is another object of the present invention to provide a flexible conducting wire structure having light emitters. By directly bonding the light emitters to the flexible conducting wires, the manufacturing efficiency is significantly improved. The economic benefits are provided, and the requirements for reducing production cost and accelerating the manufacturing speed are also satisfied.

Other objects and features of the present invention will become apparent from the following detailed description when taken in conjunction with the drawings in which:

### BRIEF DESCRIPTION OF THE DRAWINGS

FIG. 1 is a schematic view showing the assembly relationship between the related components of the present invention.

FIG. 2 is a schematic cross-sectional view showing the flexible conducting wires of the present invention.

FIG. 3 shows the series connection between the light emitting diodes of the present invention.

FIG. 4 shows the parallel connection between the light emitting diodes of the present invention.

FIG. 5 shows another preferred embodiment of the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

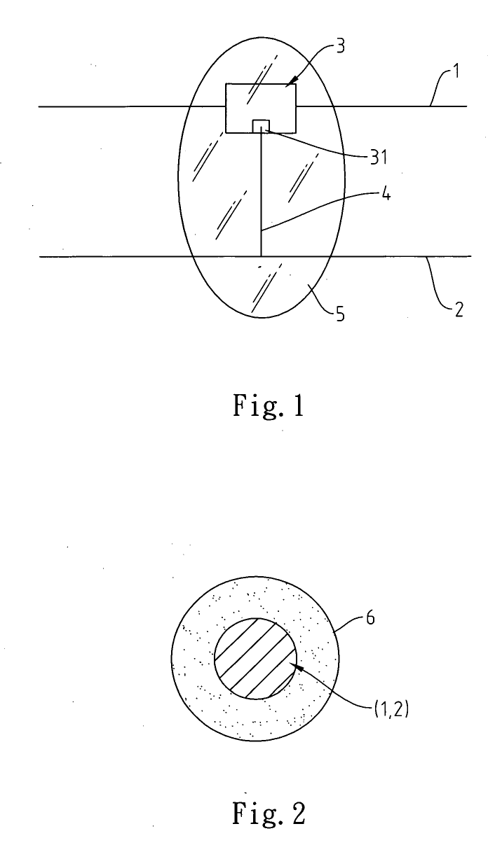

Referring to FIG. 1 and FIG. 2, a flexible conducting wire structure having light emitters of the present invention comprises two flexible conducting wires 1, 2 having different polarities and a plurality of chips 3 of a plurality of light emitting diodes (LEDs), wherein the flexible conducting wires 1, 2 are made of a high electrical conductivity material, for example, Au, Ag, Cu, etc. The chips 3 have second electrodes 31 mounted thereon, and the surfaces of the chips 3 form first electrodes. The chips of the LEDs are directly bonded on the surface of one of the flexible conducting wires, for example, the flexible conducting wire 1, by use of the surface mounting technology (SMT). Besides, the first electrode of each chip 3 is electrically connected with the flexible conducting wire 1 directly and a second electrode 31 is electrically connected with the other flexible conducting wire, for example, the flexible conducting wire 2, via a conducting wire 4 that traverses these two flexible conducting wires 1, 2. The conducting wire 4 is extremely fine and made of a high electrical conductivity material, for example, Au, Ag, Cu, etc. Besides, the chips 3 of the LEDs, two flexible conducting wires 1, 2, and the locations between them are coated with a layer of transparent adhesive namely a transparent protective cap 5 for providing the insulating protection for the chips 3 of the LEDs and the conducting wire 4. Thereafter, the flexible conducting wires 1, 2 are coated with a layer of transparent insulating adhesive namely an insulating wire cover 6 Respectively for providing the insulating protection for the flexible conducting wires 1, 2, thereby avoiding the occurrence of short circuit between the flexible conducting wires 1, 2. Therefore, the flexible conducting wire structure having light emitters is accomplished.

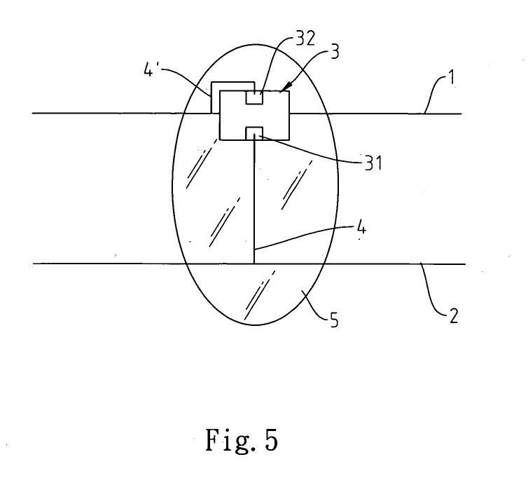

In addition to above-mentioned surface mounting technology shown in FIG. 1, another preferred embodiment of the present invention is illustrated in FIG. 5. Two electrodes 31, 32 are mounted on the chip 3, wherein a conducting wire 4′ is mounted to electrically connect the electrode 32 and the flexible conducting wire 1, and a conducting wire 4 is mounted across the flexible conducting wires 1, 2 to electrically connect the electrode 31 and the flexible conducting wire 2. The chip 3 and the flexible conducting wires 1, 2 are coated with a layer of transparent adhesive to provide them with a transparent protective cap 5.

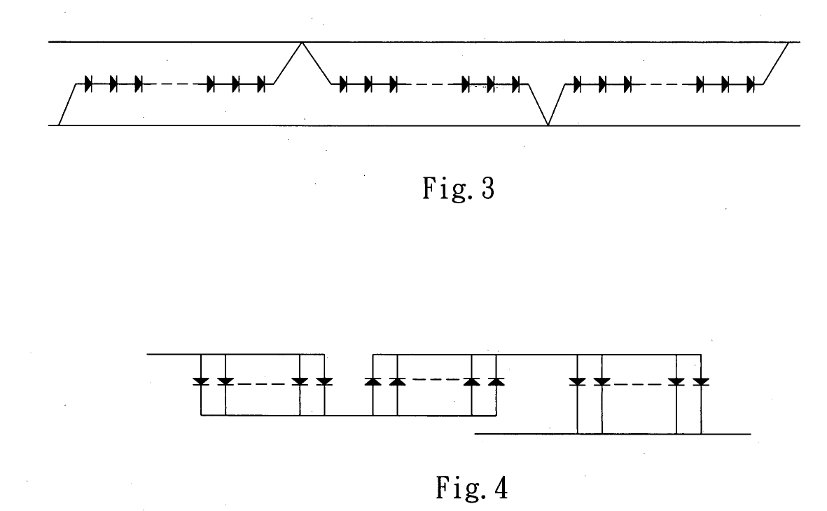

Consequently, the flexible conducting wires 1, 2 of the present invention having the directly bonded light emitting diodes can be coupled with a transformer to act the decorative light that generally winds around the decorations. When the external voltage is applied for exciting the electrons of the flexible conducting wires 1, 2 having the directly bonded light emitting diodes, the light is generated. The light emitting diodes can be electrically connected with one another in series (shown in FIG. 3) or in parallel (shown in FIG. 4) to constitute the decorative light with a plurality of light emitters.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A flexible conducting wire structure having light emitters, comprising:
two flexible conducting wires with different polarities, said flexible conducting wires being made of a high electrical conductivity material;
a plurality of light emitting diodes having a plurality of chips having first electrodes and second electrodes, said first electrodes being electrically connected with one of said flexible conducting wires, said second electrodes being electrically connected with the other of said flexible conducting wires via an extremely fine conducting wire having a high electrical conductivity, said extremely fine conducting wire being mounted across said flexible conducting wires;
a layer of transparent adhesive covered said chips of said light emitting diodes, said flexible conducting wires, and locations therebetween for providing an transparent protective cap for said chips and said extremely fine conducting wire; and
a layer of transparent insulating adhesive covered said flexible conducting wires respectively for forming an insulating wire cover to avoid the occurrence of short circuit between said two flexible conducting wires.
